(19) United States
(12) Patent Application Publication
(10) Pub. No.: US 2007/0018999 A1
(43) Pub. Date: Jan. 25, 2007

(54) Auto-centering of main image

(76) Inventors: Barinder Singh Rai, Surrey (CA); George Lyons, Langley (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/239,520

(22) Filed: Sep. 29, 2005

Related U.S. Application Data
(60) Provisional application No. 60/702,196, filed on Jul. 25, 2005.

(51) Int. Cl. G09G 5/00

(52) U.S. Cl. 345/619

(57) ABSTRACT

A display controller is provided. The display controller includes a memory configured to store image data and a register configured to store data representing a border color. Auto-centering circuitry configured to cause the image data to be displayed in a center region of a display while surrounding the center region with the border color is included. The auto-centering circuitry includes selection logic in communication with the memory and the register. The auto-centering circuitry further includes selection control logic in communication with the selection logic. The selection control logic is configured to select the image data or the border color to be output from the selection logic. Counter circuitry tracking a vertical and horizontal position on the display corresponding to the output from the selection logic is included within the auto-centering circuitry.

### CROSS REFERENCE TO RELATED APPLICATION

This application claims priority from U.S. Provisional Patent Application No. 60/702,196 filed Jul. 25, 2005, and entitled “Auto-Centering of Main Image.” This provisional application is herein incorporated by reference for all purposes.

### BACKGROUND

The popularity of handheld electronic devices with camera capability has spawned numerous applications. Users have desired to display the captured images from the handheld devices on alternate display panels. For example, it may be desired to display an image captured through a cell phone on a television or other device having a display.

Currently, the display of these images on the alternate display devices will place the captured image in the upper left hand corner of the alternate display device. In addition, where the captured image is captured through a digital camera and then displayed on a television, or similar device applying an interlaced format, the edges of the captured image on the television may appear corrupted, especially where text is involved. Thus, the captured image is not aesthetically appealing to users, and as such users tend not to take advantage of this feature.

In view of the foregoing, there is a need to provide an apparatus and a method for displaying captured images on a larger resolution display panel in an aesthetically pleasing manner and to enable the formatting of the captured image to display on a display panel in an interlaced format without format artifacts appearing.

### SUMMARY

Broadly speaking, the present invention fills these needs by providing a system and method for auto-centering an image on a display device and eliminating formatting artifacts when the image is being displayed in an interlaced format. It should be appreciated that the present invention can be implemented in numerous ways, including as a method, a system, or a device. Several inventive embodiments of the present invention are described below.

In accordance with one embodiment of the invention, a display controller is provided. The display controller includes a memory configured to store image data and a register configured to store data representing a border color. Auto-centering circuitry configured to cause the image data to be displayed in a center region of a display while surrounding the center region with the border color is included. The auto-centering circuitry includes selection logic in communication with the memory and the register. The auto-centering circuitry further includes selection control logic in communication with the selection logic. The selection control logic is configured to select the image data or the border color to be output from the selection logic. Counter circuitry tracking a vertical and horizontal position on the display corresponding to the output from the selection logic is included within the auto-centering circuitry.

In accordance with another embodiment of the present invention, an image capture device configured to output a captured image in one of interlaced or non-interlaced format is provided. The image capture device includes a central processing unit and a display controller in communication with the CPU. The display controller includes a memory configured to store image data and a register configured to store data representing a border color. Auto-centering circuitry configured to cause the image data to be displayed in a center region of an external display while surrounding the center region with the border color is also provided. The auto-centering circuitry includes selection logic in communication with the memory and the register and selection control logic in communication with the selection logic. The selection control logic is configured to select the image data or the border color to be output from the selection logic. The auto-centering circuitry also includes counter circuitry for tracking a vertical and horizontal position on the external display corresponding to the output from the selection logic.

In accordance with yet another embodiment of the present invention, a method for displaying a captured image on an external display panel having a larger size than a size of the captured image is provided. The method initiates with calculating a location of a center region of the external display panel corresponding to the size of the captured image. A location within the display panel being displayed is determined. A border color or image data is selected for display based upon whether the location within the display panel being displayed is within the location of the center region. The border color or the image data is formatted to an interlaced format for display on the external display panel.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a high level simplified schematic diagram illustrating a device in which auto-centering of an image supplied to an external display is automated in accordance with one embodiment of the invention.

FIG. 2 is a more detailed schematic diagram illustrating the auto-centering circuitry and associated logic blocks for the mobile graphics engine in accordance with one embodiment of the invention of the mobile graphics engine in accordance with one embodiment of the invention.

FIG. 3 is a simplified schematic diagram illustrating the display width and height for an auto-centered image within a display panel in accordance with one embodiment of the invention.

FIG. 4 is a simplified schematic diagram illustrating a display appearing as interlaced data on a display device.

FIG. 5 is a flow chart diagram illustrating the method operations for displaying the captured image on an external display panel having a larger size than a size of the captured image in accordance with one embodiment of the invention.

FIG. 6 is a flow chart diagram providing further details for the method operation of calculating a location of a center region of the external display panel in operation 160 of FIG. 5.

### DETAILED DESCRIPTION

An invention is described for methods and apparatuses for auto-centering an image and displaying a captured image on an external display panel in an aesthetically appealing manner. It will be obvious, however, to one skilled in the art, that the present invention may be practiced without some or all of these specific details. In other instances, well known process operations have not been described in detail in order not to unnecessarily obscure the present invention.

The embodiments described herein provide a method and apparatus where an image captured through a digital camera, camcorder, cell phone with camera capability, etc., may be displayed on an external display panels, i.e., a display panel other than the display panel integrated into the device capturing the image. For example, an image captured through a digital camera, camcorder, cell phone, etc., may be displayed on a computer display panel, television, or some other suitable external display panel. The embodiments described below will guarantee the captured image, when smaller than the display resolution for the external display panel, is auto-centered onto the external display panel. In addition, the embodiments described below may be applied with equally appealing results to either interlaced or non-interlaced formats. As an added benefit, a border will be applied around the auto-centered image to further enhance the display. The manner in which these embodiments are executed will minimize memory accesses and be performed through the display controller of the handheld electronic device rather than a central processing unit of the hand held device in order to conserve power and free up bandwidth.

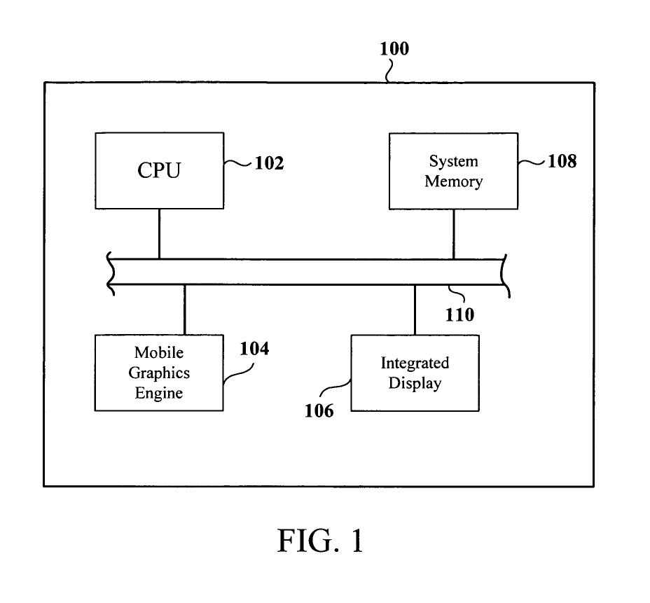

FIG. 1 is a high level simplified schematic diagram illustrating a device in which auto-centering of an image supplied to an external display is automated in accordance with one embodiment of the invention. Device 100 includes central processing unit (CPU) 102, mobile graphics engine (MGE) 104, system memory 108, integrated display 106, each of which is in communication with each other over bus 110. It should be appreciated that the term mobile graphics engine, as used herein, may refer to a graphics controller or display controller. Device 100 may be any hand-held portable electronic device, e.g., a cell phone, a personal digital assistant, a web tablet, a pocket personal computer, digital camera, camcorder, etc. As will be described below in more detail, a device and method for auto-centering images automatically is provided where the start and end x/y coordinates are calculated by MGE 104. CPU 102 does not need to perform these calculations, thereby freeing up the CPU to perform other tasks. Additionally, power is saved since the calculation and the programming of MGE 104 does not have to be done. Another advantage of the embodiments described below is that it s not necessary to program registers is necessary, as a result bandwidth between the CPU to MGE is freed up.

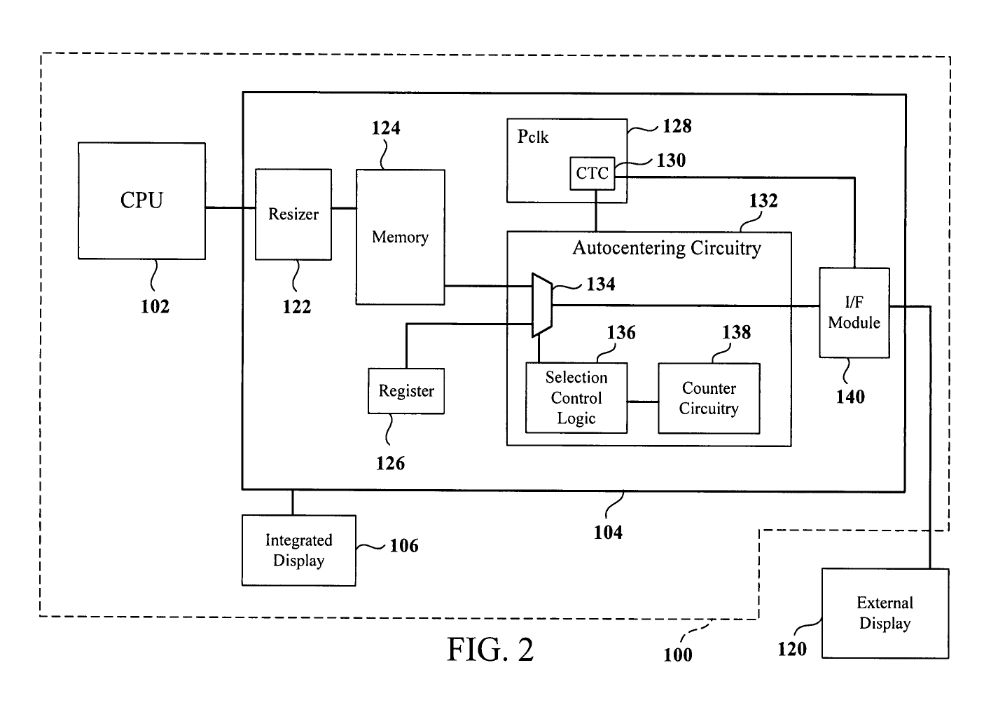

FIG. 2 is a more detailed schematic diagram illustrating the auto-centering circuitry and associated logic blocks for the mobile graphics engine in accordance with one embodiment of the invention. Device 100 includes CPU 102 integrated display 106, and MGE 104. Within MGE 104 is included resizer 122, which has the capability of reducing an image size prior to storing in memory 124. It should be appreciated, that in some instances, an image captured either through camera functionality associated with device 100 or downloaded into device 100 may be larger than the resolution provided by external display 120. For example, a 3.3 Megapixel image from a digital camera has a resolution of 1700×1200, which can't be displayed on a standard television display. Thus, resizer 122 can reduce the image size to 740×480 or some other suitable size to fit on a television display. The reduced size image is then stored in memory 124. It should be appreciated, that reducing the image size will further conserve the on-chip memory space of memory 124 on MGE 104. MGE 104 includes register 126, which is configured to store a border color, which will define the border around the auto-centered image stored in memory 124. That is, when the image data is displayed on external display 120, the image will be centered within the external display while the border color defined by a value stored within register 126 will surround the image on the display. In one embodiment, the border color is user programmable.

Still referring to FIG. 2, image data from memory 124 and the border color value from register 126 are input into the multiplexor 134 of auto-centering circuitry 132. Auto-centering circuitry 132 also includes selection control logic 136 and counter circuitry 138. The selected output from multiplexor 134 is transmitted to interface (I/F) module 140 according to the select signal provided by selection control logic 136. Interface module 140 then transmits the image data or border color to external display 120 for presentation on the external display. The timing signals for MGE 104 re provided through clock unit 128 (P_{clk}). Clock unit 128 includes CTC block 130. CTC block 130 provides timing signals for the logic located on MGE 104. In one embodiment of the invention, interface module 140 includes a digital to analog converter in order to transform the output of auto-centering circuitry 132 to an interlaced format for display on external display 120. In this embodiment, external display 120 may be a television, or some other display that presents data in an interlaced format. In contrast, integrated display 106 is a display that presents data in a non-interlaced format in accordance with one embodiment of the invention. For example, where device 100 is a cell phone, integrated display 106 may be a liquid crystal display (LCD). One skilled in the art will appreciate that common interlaced formats include National Television System Committee (NTSC), PAL, and other common formats used for interlace data. In one embodiment, interface module 140 includes a front porch and a back porch signal, wherein the front porch is a portion of a waveform scan that represents the horizontal blanking at the end of the line of video, while the back porch is the portion of the waveform scan that represents the horizontal blanking at the beginning of a line of video.

Counter circuitry 138 of FIG. 2, within auto-centering circuitry 132 and tracks a vertical and a horizontal display position being transmitted to display 120. Here, a vertical and horizontal counter may be included within counter circuitry 138. It should be appreciated that the horizontal counter will be re-set at the end of a horizontal line, while the vertical counter is re-set at the end of a frame of data. Selection control logic 136 includes logic gates that define the functionality described with respect to Table 1. The start X/Y and end X/Y coordinates for interlaced image data is provided by the selection control logic 136. These coordinates may be determined through the code specified in Table 1. Of course, selection control logic 136 may also handle calculating position data for non-interlaced data to be presented on external display 120, when the external display is configured to handle non-interlaced data. Exemplary calculation data for non-interlaced data is provided in Table 2. The timing signals provided by CTC block 130 provide timing indications as to when to insert a vertical re-trace and a horizontal re-trace signal common to the interlaced formnat. It should be appreciated that while one register 126 is illustrated in MGE 104, this is not meant to be limiting as any number of registers may be provided within the MGE.

TABLE 1
assign hAutoCentreOn = ((RegTvMainWidth < RegTvHDispWidth) &
RegAutoCenterEn);
// Calculating the autocentred horizontal start for main.
assign hMainDispDiff = (RegTvHDispWidth − RegTvMainWidth); //
difference.
assign hStartPos[8:0] = hMainDispDiff[9:1]; // div 2.
assign newhStartPos[8:0] = hStartPos;
// This is for cases when main is smaller than display.
assign newRegTvHMainWidth[9:0] = RegTvMainWidth +
10′b1111111111;
// Calculating the autocentred horizontal end for main.
assign newhEndPos[9:0] = ({1′b0,newhStartPos[8:0]} +
RegTvMainWidth) − 10′b00_0000_0001;
// Renaming signals for sending to the tv pipe. In cases when
autocentre is off
// the physical display registers are used as the start and end values.
assign intTCtcMainXStart = hAutoCentreOn ? newhStartPos :
9′b000_000_000;
assign intTCtcMainXEnd = hAutoCentreOn ? newhEndPos :
newRegTvHMainWidth;
// RegTvHDispWidth contains the physical value of display width. In
hardware we
// count from 0 so the max value should be RegLcdHDispWidth − 1.
Subtracting is
// done using 2′s complement (1 inverted and add 1).
assign newRegTvHDispWidth[9:0] = RegTvHDispWidth +
10′b1111111111;
assign newRegTvVDispHeight = RegFlickerFilterEn ?
RegTvVDispHeight[9:0]
:
{1′b0, RegTvVDispHeight[9:1]};
// The difference between the display and main image is used to
calculate the
// main start position.
assign vMainDispDiff[9:0] = (RegTvVDispHeight − RegTvMainHeight);

| assign vStartPos[8:0] = | RegFlickerFilterEn ? vMainDispDiff[9:1] : | |
|---|---|---|
| | TvFieldOdd ? | {1′b0,vMainDispDiff[9:2]} : |
| | | ({1′b0,vMainDispDiff[9:2]} + |

{8′b0000_0000,vMainDispDiff[1]});
assign intTCtcMainYStart[8:0] = vStartPos;
assign newvEndPos[9:0] = {1′b0,vMainDispDiff[9:1]} +
RegTvMainHeight[9:0] −

10′b00_0000_0001;

| assign vEndPos[9:0] = | RegFlickerFilterEn ? newvEndPos[9:0] : | |
|---|---|---|
| | TvFieldOdd ? | ({1′b0,newvEndPos[9:1]} − |
| | | {9′b0_0000_0000, |
| | | !newvEndPos[0]}) : |
| | | {1′b0,newvEndPos[9:1]}; |

assign intTCtcMainYEnd[9:0] = vEndPos;

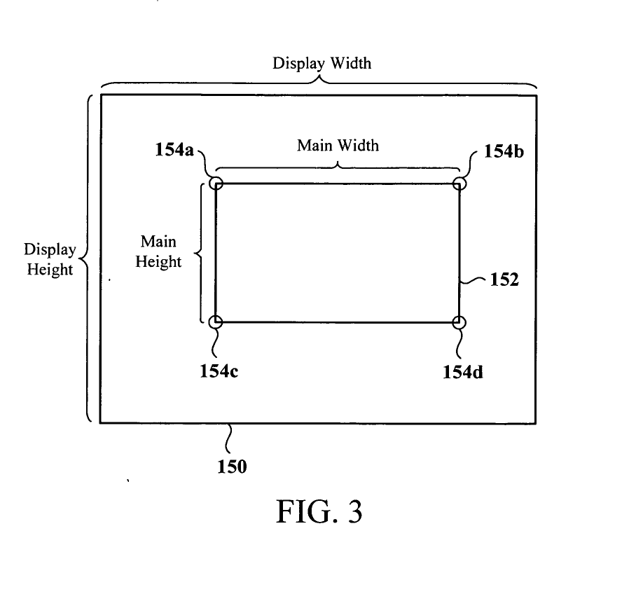

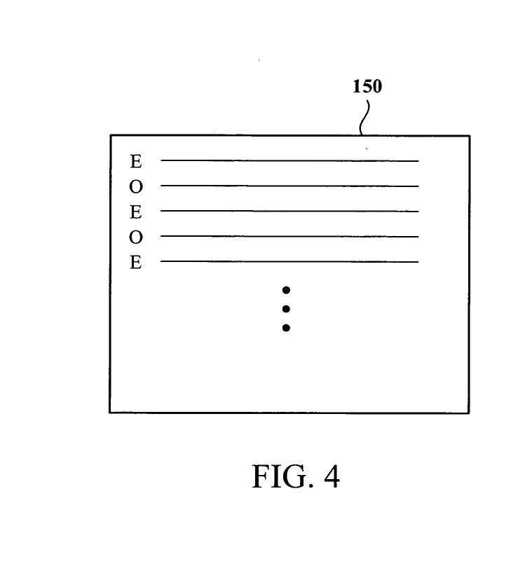

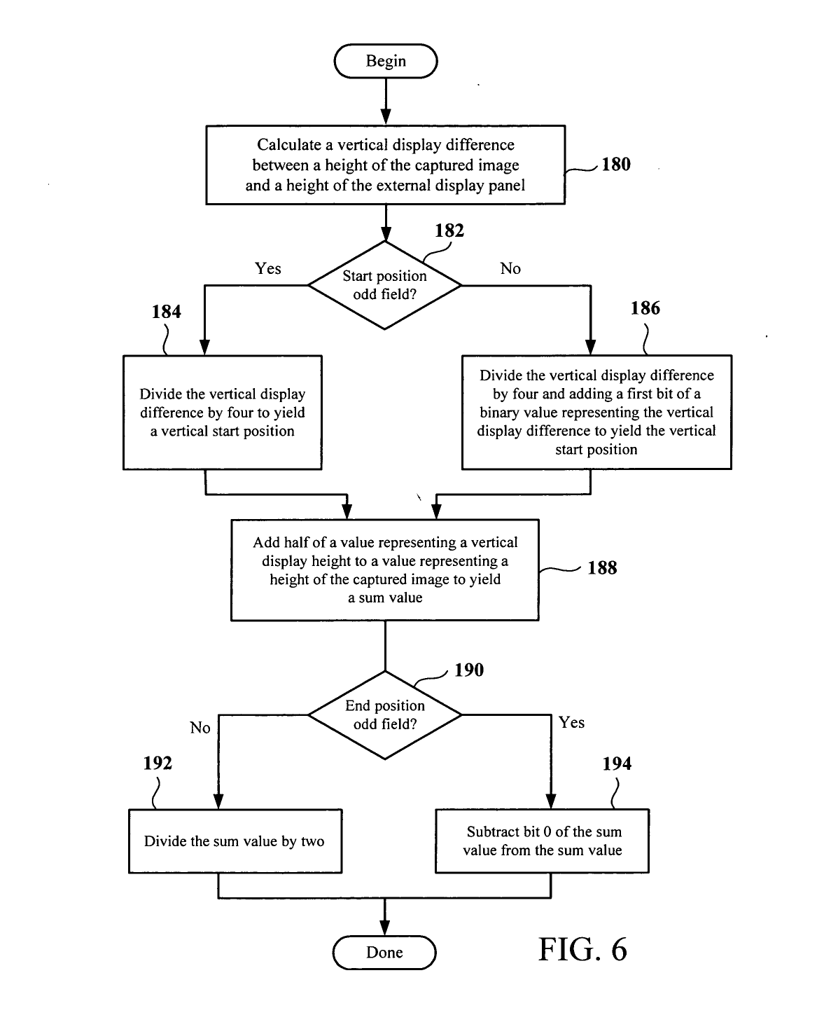

FIG. 3 is a simplified schematic diagram illustrating the display width and height for an auto-centered image within a display panel in accordance with one embodiment of the invention. Display panel 150, which may correspond to external display panel of 120 of FIG. 2, may be defined by a display height and a display width. For example, as is common with television display, the width may be 720 pixels and the display height may be 480 lines. However, as illustrated with reference to FIG. 4, with alternating even and odd lines the display height may be considered half of the 480 actual lines, since only half of the lines are shown each cycle. Within display panel 150 is centered main image 152. Main image 152 is associated with a main width and a main height. The start X/Y and end X/Y coordinates correspond to points 154a through 154d. In one embodiment, these coordinates are calculated through the illustrative code of Table 1 for an interlaced display. As will be explained in further detail with references to FIGS. 6 and 7, the illustrative code of Table 1 takes into account whether display 150 is formatted for interlaced data. One skilled in the art will appreciate that when display 150 is formatted for non-interlaced data, the calculations become much more straightforward as illustrated below in Table 2.

In one exemplary instance the display device is 100 by 100 pixels and the image coming from a camera is 20 by 20 pixels. In one embodiment, the auto-centering circuitry and selection control logic of FIG. 2 calculates the Start and End position of the main image within the display. In the example above, the following variables are calculated.

TABLE 2

StartX = (100 − 20)/2 = 40
EndX = StartX + 20 = 60
StartY = (100 − 20)/2 = 40
EndY = StartY + 20 = 60

FIG. 4 is a simplified schematic diagram illustrating a display appearing as interlaced data on a display device. Display 150 includes a number of even and odd lines which are alternatively displayed. With respect to interlace scanning, first all the odd lines are scanned from top to bottom, and the even lines are skipped. After the vertical scanning cycle, a rapid vertical re-trace causes the electron scanning beam to return to the top of the frame. Thereafter, all the even lines that were omitted in the first scanning are scanned from top to bottom. Each frame becomes divided into two fields. The first, and all the following odd fields, contain the odd lines in the frames. The second, and all the even fields, include the even scanning lines. Given two fields per frame and thirty complete frames scanned per section, the field repetition rate is 60 per second and the vertical scanning frequency is 60 Hz in one embodiment. It should be appreciated that in order to reduce flicker that is associated with interlaced scanning, flicker filters may be used to eliminate the flicker in the image. In accordance with one embodiment of the invention, a flicker filter may average values from an even and odd line in order to reduce any flicker. That is, instead of a white/black change between frames, the flicker filter will provide a white/gray change by averaging the values of the adjacent lines.

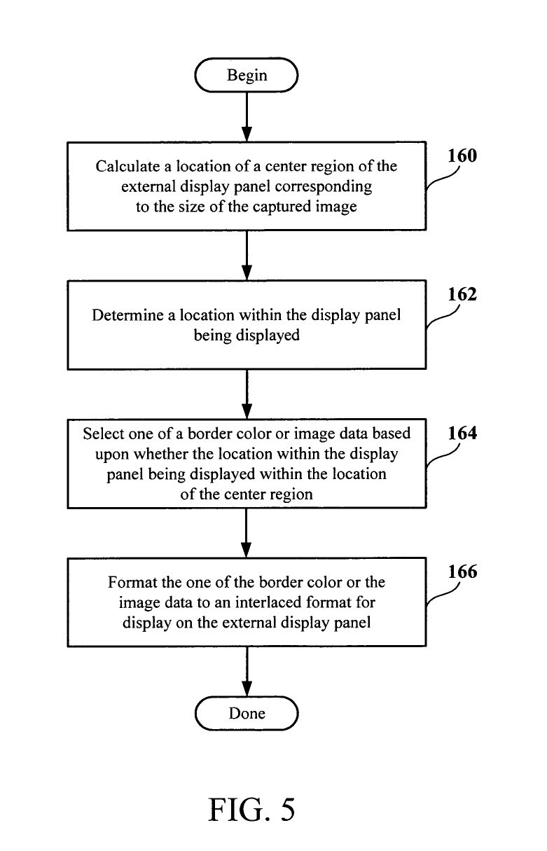

FIG. 5 is a flow chart diagram illustrating the method operations for displaying the captured image on an external display panel having a larger size than a size of the captured image in accordance with one embodiment of the invention. The method initiates with operation 160 where a location of a center region of the external display panel corresponding to the size of the captured image is calculated. In operation 160 the start X/Y and end X/Y coordinates are calculated as defined in Table 1 in accordance with one embodiment of the invention. Of course, if the data is to be presented in a non-interlaced format, logic accomplishing the functionality described with reference to Table 2 may be used. It should be noted that an enable bit may be set to define whether the interlaced or non-interlaced format is applied. Additionally, the auto-centering feature may be bypassed through another enable bit, in one embodiment of the invention.

The method then proceeds to operation 162 where a location within the display panel being displayed is determined. It should be appreciated that the location within the display panel being displayed may be determined through the counter circuitry discussed with reference to FIG. 2. The method then advances to operation 164 where a border color or image data is selected based upon whether the location within the display panel being displayed is within the location of the center region identified in operation 160. The selection control logic discussed with reference to FIG. 2 performs operation 164 through the logic gates that make the calculations discussed with reference to Table 1. The method then proceeds to operation 166 where the border color or the image data is formatted to an interlace standard for display on the external display panel. As discussed above with reference to FIG. 2, an interface module may perform this function where additional data, such as the back porch and the front porch are incorporated with the image data or border data being transmitted to an external display.

FIG. 6 is a flow chart diagram providing further details for the method operation of calculating a location of a center region of the external display panel in operation 160 of FIG. 5. It should be appreciated that FIG. 6 is directed towards handling interlaced data so that the interlaced data appears uncorrupted to a viewer. That is, while non-interlaced data methods may be applied to auto-center the image data on an interlaced type display, the image data will have artifacts from the non-interlaced data methods. The method initiates with operation 180 where a vertical display difference is calculated between a height of the captured image and a height of the external display panel. As illustrated with reference to FIG. 3, the vertical display difference between the captured image and the external display is calculated here.

The method then proceeds to decision operation 182 where it is determined if the start position is an odd field or an even field. If the start position is an odd field, the method advances to operation 184 where the vertical display difference calculated in operation 180 is divided by four to yield a vertical start position. If the start position is an even field in decision operation 182, the method moves to operation 186 where the vertical display difference is divided by four and a first bit of a binary value representing the vertical display difference is added to that result in order to yield the vertical start position. Thus, the vertical start position for an even field may be adjusted by one line. From operations 184 and 186 the method moves to operation 188. In operation 188 half of a value representing a vertical display height is added to a value representing a height of the captured image to yield a sum value. The method then moves to decision operation 190 where it is determined if an end position is associated with an odd field.

If the end position is associated with an odd field, then the method proceeds to operation 194 where bit zero of the sum value determined in operation 188 is subtracted from that sum value. If the end position is an even field in decision operation 190, the method moves to operation 192 where the sum value determined in operation 188 is divided by two. Thereafter the method terminates. It should be appreciated that operations 180 through 186 will determine the vertical start points, while operations 188 through 194 determine the vertical stop points, in order to define the placement of the auto-centered image on an external display device.

In summary, the above-described invention provides a scheme for displaying image data on interlaced and non-interlaced type display panels. Techniques to handle either type of data format are applied so that the presented image is free from artifacts.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A display controller, comprising:
a memory configured to store image data;
a register configured to store data representing a border color;
auto-centering circuitry configured to cause the image data to be displayed in a center region of a display while surrounding the center region with the border color, the auto-centering circuitry including,
selection logic in communication with the memory and the register;
selection control logic in communication with the selection logic, the selection control logic configured to select one of the image data or the border color to be output from the selection logic; and
counter circuitry tracking a vertical and horizontal position on the display corresponding to the output from the selection logic.

2. The display controller of claim 1, further comprising:
an interface module configured to receive the output from the selection logic, the interface module capable of formatting the output from the selection logic to an interlaced standard.

3. The display controller of claim 2, wherein the interface module is further configured to convert the output from the selection logic from a digital format to an analog format.

4. The display controller of claim 1, wherein the selection logic is a 2:1 multiplexer and the selection control logic is a plurality of logic gates configured to identify a position of the center region on the display, the plurality of logic gates configured to adjust the position of the center region based upon whether a flicker filter is enabled.

5. The display controller of claim 1, wherein the auto-centering circuitry further comprises:
counter circuitry tracking both a vertical position and a horizontal position corresponding to the output of the selection logic.

6. The display controller of claim 1, further comprising:
a single clock generator, the single clock generator providing timing signals for the auto-centering circuitry and timing signals for an interface module in communication with the selection logic, wherein the timing signals for the interface module are configured to trigger insertion of a horizontal retrace signal and a vertical retrace signal.

7. The display controller of claim 2, wherein the interface module inserts a horizontal blanking signal at both a beginning and an end of a horizontal line being displayed on the display.

8. An image capture device configured to output a captured image in one of interlaced or non-interlaced format, comprising:
a central processing unit;
a display controller in communication with the CPU; the display controller including,
a memory configured to store image data;
a register configured to store data representing a border color;
auto-centering circuitry configured to cause the image data to be displayed in a center region of an external display while surrounding the center region with the border color, the auto-centering circuitry including,
selection logic in communication with the memory and the register;
selection control logic in communication with the selection logic, the selection control logic configured to select one of the image data or the border color to be output from the selection logic; and
counter circuitry tracking a vertical and horizontal position on the external display corresponding to the output from the selection logic.

9. The device of claim 8, further comprising:
a display panel integrated into the device, the display panel integrated into the device configured to display non-interlaced data and the external display configured to display interlaced data.

10. The device of claim 8, wherein the display controller further comprises:
an interface module configured to receive the output from the selection logic, the interface module capable of converting the output from the selection logic to an interlaced format for the external display.

11. The device of claim 10, wherein the interface module is further configured to convert the output from the selection logic from a digital format to an analog format.

12. The device of claim 8, wherein the selection logic is a 2:1 multiplexer and the selection control logic is a plurality of logic gates configured to identify a position of the center region on the external display, the plurality of logic gates configured to adjust the position of the center region based upon whether a flicker filter is enabled.

13. The device of claim 8, wherein the auto-centering circuitry further comprises:
counter circuitry tracking both a vertical position and a horizontal position corresponding to the output of the selection logic.

14. The device of claim 8, further comprising:
a single clock generator associated with the display controller, the single clock generator providing timing signals for the auto-centering circuitry and timing signals for an interface module in communication with the selection logic, wherein the timing signals for the interface module are configured to trigger insertion of a horizontal retrace signal and a vertical retrace signal.

15. The device of claim 10, wherein the interface module inserts a horizontal blanking signal at both a beginning and an end of a horizontal line being displayed on the display.

16. A method for displaying a captured image on an external display panel having a larger size than a size of the captured image, comprising:
calculating a location of a center region of the external display panel corresponding to the size of the captured image;
determining a location within the display panel being displayed;
selecting one of a border color or image data based upon whether the location within the display panel being displayed within the location of the center region; and
formatting the one of the border color or the image data to an interlaced format for display on the external display panel.

17. The method of claim 16, further comprising:
storing the image data in memory;
storing a value representing the border color in a register; and
converting the one of the border color or the image data from a digital signal to an analog signal prior to display on the external display panel.

18. The method of claim 16, wherein the method operation of calculating a location of a center region of the external display panel corresponding to the size of the captured image includes,
calculating a vertical display difference between a height of the captured image and a height of the external display panel;
determining if a start position is an odd field;
dividing the vertical display difference by four if the start position is an odd field to yield a vertical start position; and
dividing the vertical display difference by four and adding a first bit of a binary value representing the vertical display difference if the start position is an even field to yield the vertical start position.

19. The method of claim 16, further comprising:
determining whether a border width encompasses one of an even or odd number of lines; and if the border width encompasses an odd number of lines, the method includes,
adjusting a starting point of an even field by a single line in a vertical direction.

20. The method of claim 18, further comprising:
calculating a vertical end position, the calculating including,
adding half of a value representing a vertical display height to a value representing a height of the captured image to yield a sum value;
determining if the vertical end position is within an odd field;
dividing the sum value by two if the vertical end position is within an even field; and
subtracting bit 0 of the sum value from the sum value if the vertical end position is within an odd field.
